(19) United States
(12) Patent Application Publication
(10) Pub. No.: US 2026/0323382 A1
(43) Pub. Date: Oct. 15, 2026

(54) MECHANISM FOR BUFFER STATUS REPORT

(71) Applicant: Nokia Technologies Oy, Espoo (FI)

(72) Inventors: Boyan YANAKIEV, Aalborg (DK); Benoist Pierre SEBIRE, Tokyo (JP); Chunli WU, Beijing (CN)

(21) Appl. No.: 19/485,340

(22) PCT Filed: May 29, 2023
(86) PCT No.: PCT/CN2023/096838

§ 371 Date: Nov. 18, 2025

(51) Int. Cl. H04W 28/02

(52) U.S. Cl. CPC H04W 28/0278; H04W 28/0268

(57) ABSTRACT

Embodiments of the present disclosure relates to a solution for transmitting a buffer status report. In particular, a network device transmits a configuration of one or more logical channel groups to a terminal device. The network device also transmits a configuration indication whether at least one logical channel group is able to use an additional buffer size table to the terminal device. The terminal device determines which buffer size table to be used based on a type of buffer status report for the at least one logical channel group. The terminal device transmits a buffer status report to the network device based on the determined buffer size table. In this way, it can simplify the padding buffer status report procedure when there is data buffered for logical channel groups both with and without additional buffer size table used.

### FIELDS

Various example embodiments of the present disclosure generally relate to the field of telecommunication and in particular, to methods, devices, apparatuses and computer readable storage medium for buffer status report.

### BACKGROUND

A buffer status report (BSR) is used by user equipment (UE) to report its buffered data status to gNB to help the gNB make a right scheduling. BSR can be defined in medium access control (MAC) layer to indicate how much data are buffered in which logical channel group (LCG). In a current BSR procedure, for regular and periodic BSR, whether to report a long or short BSR depends on, whether there are more than one LCG with data buffered. For padding BSR, whether truncated BSR is reported depends on whether there is enough space for all the BS to indicate all the data available for transmission. Extended reality (XR) is a combination of augmented reality, virtual reality, and mixed reality, efficient support of XR services imposes some challenges for new radio (NR). It has proposed enhancements for support of XR services. Therefore, BSR enhancement for the XR services is a key objective to study.

### SUMMARY

In a first aspect of the present disclosure, there is provided a first device. The first device comprises at least one processor; and at least one memory storing instructions that, when executed by the at least one processor, cause the first device to: receive, from a second device, a first configuration of one or more logical channel groups; receive, from the second device, a second configuration indicating whether at least one logical channel group of the one or more logical channel groups is able to use a second buffer size table in addition to a first set of buffer size tables; determine, from the first set of buffer size tables and the second buffer size table, a target buffer size table to be used for a buffer status report of the at least one logical channel group based on a type of buffer status report; and transmit, to the second device, the buffer status report that is based on the target buffer size table.

In a second aspect of the present disclosure, there is provided a second device. The second device comprises at least one processor; and at least one memory storing instructions that, when executed by the at least one processor, cause the second device to: transmit, to a first device, a first configuration of one or more logical channel groups; transmit, to the first device, a second configuration indicating whether at least one logical channel group of the one or more logical channel groups is able to use a second buffer size table in addition to a first set of buffer size tables; and transmit, to the second device, a buffer status report for the at least one logical channel group that is based on a target buffer size table, wherein the target buffer size table is determined from the first set of buffer size tables and the second buffer size table based on a type of buffer status report.

In a third aspect of the present disclosure, there is provided a method. The method comprises: receiving, at a first device and from a second device, a first configuration of one or more logical channel groups; receiving, from the second device, a second configuration indicating whether at least one logical channel group of the one or more logical channel groups is able to use a second buffer size table in addition to a first set of buffer size tables; determining, from the first set of buffer size tables and the second buffer size table, a target buffer size table to be used for a buffer status report of the at least one logical channel group based on a type of buffer status report; and transmitting, to the second device, the buffer status report that is based on the target buffer size table.

In a fourth aspect of the present disclosure, there is provided a method. The method comprises: transmitting, at a second device and to a first device, a first configuration of one or more logical channel groups; transmitting, to the first device, a second configuration indicating whether at least one logical channel group of the one or more logical channel groups is able to use a second buffer size table in addition to a first set of buffer size tables; and transmitting, to the second device, a buffer status report for the at least one logical channel group that is based on a target buffer size table, wherein the target buffer size table is determined from the first set of buffer size tables and the second buffer size table based on a type of buffer status report.

In a fifth aspect of the present disclosure, there is provided a first apparatus. The first apparatus comprises means for receiving, from a second apparatus, a first configuration of one or more logical channel groups; means for receiving, from the second apparatus, a second configuration indicating whether at least one logical channel group of the one or more logical channel groups is able to use a second buffer size table in addition to a first set of buffer size tables; means for determining, from the first set of buffer size tables and the second buffer size table, a target buffer size table to be used for a buffer status report of the at least one logical channel group based on a type of buffer status report; and means for transmitting, to the second apparatus, the buffer status report that is based on the target buffer size table.

In a sixth aspect of the present disclosure, there is provided a second apparatus. The second apparatus comprises means for transmitting, to a first apparatus, a first configuration of one or more logical channel groups; means for transmitting, to the first device apparatus a second configuration indicating whether at least one logical channel group of the one or more logical channel groups is able to use a second buffer size table in addition to a first set of buffer size tables; and means for receiving, from the first apparatus, a buffer status report for the at least one logical channel group that is based on a target buffer size table, wherein the target buffer size table is determined from the first set of buffer size tables and the second buffer size table based on a type of buffer status report.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for transmitting a buffer status report (BSR) according to some example embodiments of the present disclosure;

FIG. 3A to FIG. 3D illustrate schematic diagrams of medium access control (MAC) control element (CE) formats for transmitting the BSR, respectively;

FIG. 4 illustrates a schematic diagram of MAC CE format for transmitting the BSR according to example embodiments of the present disclosure;

FIG. 5 illustrates a flowchart of a method for determining a MAC CE according to example embodiments of the present disclosure;

FIG. 6 illustrates a flowchart of a method implemented at a first device according to some example embodiments of the present disclosure;

FIG. 7 illustrates a flowchart of a method implemented at a second device according to some example embodiments of the present disclosure;

FIG. 8 illustrates a simplified block diagram of a device that is suitable for implementing example embodiments of the present disclosure; and

FIG. 9 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “logical channel group (LCG)” used herein may refer to a collection of logical channels in a wireless communication system. A logical channel may be used to carry different types of data, such as voice, video, and control signaling, between the base station and mobile devices. LCGs may be used to allocate resources, such as bandwidth and time slots, to different logical channels, based on the priority and quality of service requirements.

As used herein, the term “buffer status report (BSR)” used herein may refer to information about uplink data volume in a MAC entity of a terminal device that is provided to a network device. The term “buffer size table” used herein may refer to a table that indicates buffer size levels for a buffer size field. The term “medium access control (MAC) control element (CE)” used herein may refer to a MAC structure that carries control information.

As mentioned above, BSR enhancement for the XR services is a key objective to study. For XR, a current assumption is that it may be per LCG configurable either a new buffer size (BS) table or a legacy BS table. In case of only 8 bits new table is defined for XR, as for regular and periodic BSR, it is fine to reuse the legacy BS table by allowing reporting long BSR even if there is only one LCG with data buffered. However, it is only concerned regular and periodic BSR without considering padding BSR. But for the padding BSR, there is not enough available bit for BS reporting. If only 8 bits BS can be reported in the padding BSR, for the case of only one byte space left, it will only be able to indicate the 8 bits bitmap for the LCG IDs without any BS information which is even worse than legacy. Therefore, a solution on buffer status report for XR is needed.

### Example Environment

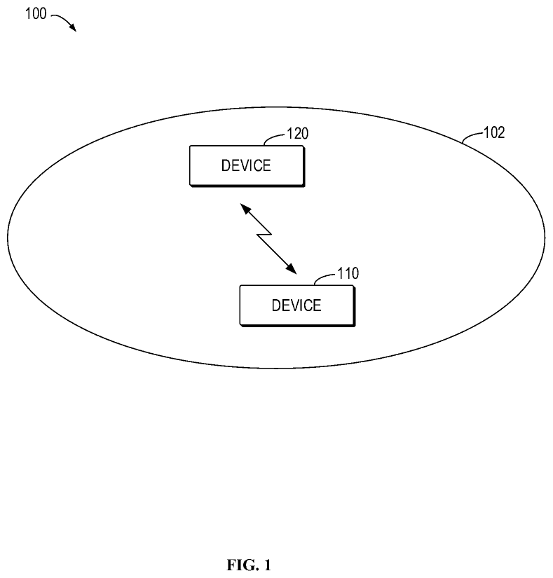

FIG. 1 illustrates an example communication environment 100 in which example embodiments of the present disclosure can be implemented. In the communication environment 100, a plurality of devices, including a device 110 (referred to as “first device” hereinafter) and a device 120 (referred to as “second device” hereinafter), can communicate with each other. The device 110 may be in a coverage of a serving cell 102.

In the following, for the purpose of illustration, some example embodiments are described with the device 110 operating as a terminal device and the device 120 operating as a network device. However, in some example embodiments, operations described in connection with a terminal device may be implemented at a network device or other device, and operations described in connection with a network device may be implemented at a terminal device or other device.

In some example embodiments, if the device 110 is a terminal device and the device 120 is a network device, a link from the device 120 to the device 110 is referred to as a downlink (DL), and a link from the device 110 to the device 120 is referred to as an uplink (UL). In DL, the device 120 is a transmitting (TX) device (or a transmitter) and the device 110 is a receiving (RX) device (or a receiver). In UL, the device 110 is a TX device (or a transmitter) and the device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Work Principle and Example Signaling for Communication

According to some example embodiments of the present disclosure, there is provided a solution for transmitting a BSR. In particular, a network device transmits a configuration of one or more logical channel groups to a terminal device. The network device also transmits a configuration indicating whether at least one logical channel group of the one or more logical channel groups is able to use an additional buffer size table to the terminal device. The terminal device determines which buffer size table to be used based on a type of buffer status report for the at least one logical channel group. The terminal device transmits a buffer status report to the network device. In this way, it can simplify the padding BSR procedure when there is data buffered for LCGs both with and without new BS table configured/used.

Example embodiments of the present disclosure will be described in detail below with reference to the accompanying drawings.

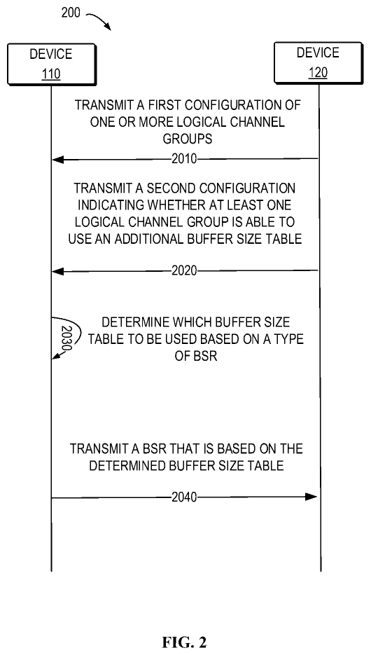

Reference is now made to FIG. 2, which shows a signaling chart 200 for communication according to some example embodiments of the present disclosure. As shown in FIG. 2, the signaling chart 200 involves the device 110 and the device 120.

The device 120 transmits (2010) a configuration (also referred to as “first configuration”) of one or more logical channel groups to the device 110. In other words, the device 110 receives the first configuration of one or more logical channel groups from the device 120. The first configuration may indicate which logical channel(s) is allocated to the one or more logical channel groups. The maximum number of LCGs may be eight. The first configuration may include any suitable parameters that can be used to configure the one or more logical channel groups.

The device 120 transmits (2020) to the device 110 a configuration (also referred to as “second configuration”) indicating whether at least one logical channel group of the one or more channel groups is able to use an additional buffer size table (also referred to as “second buffer size table”) in addition to a set of buffer size tables (also referred to as “a first set of buffer size tables”). In other words, the device 110 receives the second configuration from the device 120. In some example embodiments, the first configuration and the second configuration may be transmitted/received in a same configuration message. Alternatively, the first configuration and the second configuration may be transmitted/received in difference configuration messages.

In some example embodiments, the one or more logical channel groups may be able to use a set of buffer size tables. The set of buffer size tables may be pre-configured at the device 110. The set of buffer size tables may include a 5-bit buffer size table and an 8-bit buffer size table. For example, the one or more logical channel groups may be able to use a 5-bit buffer size table. Table 1 is the 5-bit buffer size table which shows buffer size levels (in bytes) for 5-bit buffer size field.

TABLE 1
Buffer size levels (in bytes) for 5-bit Buffer Size field

| | BS |
|---|---|
| Index | value |
| 0 | 0 |
| 1 | ≤10 |
| 2 | ≤14 |
| 3 | ≤20 |
| 4 | ≤28 |
| 5 | ≤38 |
| 6 | ≤53 |
| 7 | ≤74 |
| 8 | ≤102 |
| 9 | ≤142 |
| 10 | ≤198 |
| 11 | ≤276 |
| 12 | ≤384 |
| 13 | ≤535 |
| 14 | ≤745 |
| 15 | ≤1038 |
| 16 | ≤1446 |
| 17 | ≤2014 |
| 18 | ≤2806 |
| 19 | ≤3909 |
| 20 | ≤5446 |
| 21 | ≤7587 |
| 22 | ≤10570 |
| 23 | ≤14726 |
| 24 | ≤20516 |
| 25 | ≤28581 |
| 26 | ≤39818 |
| 27 | ≤55474 |
| 28 | ≤77284 |
| 29 | ≤107669 |
| 30 | ≤150000 |
| 31 | >150000 |

Alternatively, the one or more logical channel groups may be able to use an 8-bit buffer size table. Table 2 is the 8-bit buffer size table which shows buffer size levels (in bytes) for 8-bit buffer size field.

TABLE 2
Buffer size levels (in bytes) for 8-bit Buffer Size field

| | BS |
|---|---|
| Index | value |
| 0 | 0 |
| 1 | ≤10 |
| 2 | ≤11 |
| 3 | ≤12 |
| 4 | ≤13 |
| 5 | ≤14 |
| 6 | ≤15 |
| 7 | ≤16 |
| 8 | ≤17 |
| 9 | ≤18 |
| 10 | ≤19 |
| 11 | ≤20 |
| 12 | ≤22 |
| 13 | ≤23 |
| 14 | ≤25 |
| 15 | ≤26 |
| 16 | ≤28 |
| 17 | ≤30 |
| 18 | ≤32 |
| 19 | ≤34 |
| 20 | ≤36 |
| 21 | ≤38 |
| 22 | ≤40 |
| 23 | ≤43 |
| 24 | ≤46 |
| 25 | ≤49 |
| 26 | ≤52 |
| 27 | ≤55 |
| 28 | ≤59 |
| 29 | ≤62 |
| 30 | ≤66 |
| 31 | ≤71 |
| 32 | ≤75 |
| 33 | ≤80 |
| 34 | ≤85 |
| 35 | ≤91 |
| 36 | ≤97 |
| 37 | ≤103 |
| 38 | ≤110 |
| 39 | ≤117 |
| 40 | ≤124 |
| 41 | ≤132 |
| 42 | ≤141 |
| 43 | ≤150 |
| 44 | ≤160 |
| 45 | ≤170 |
| 46 | ≤181 |
| 47 | ≤193 |
| 48 | ≤205 |
| 49 | ≤218 |
| 50 | ≤233 |
| 51 | ≤248 |
| 52 | ≤264 |
| 53 | ≤281 |
| 54 | ≤299 |
| 55 | ≤318 |
| 56 | ≤339 |
| 57 | ≤361 |
| 58 | ≤384 |
| 59 | ≤409 |
| 60 | ≤436 |
| 61 | ≤464 |
| 62 | ≤494 |
| 63 | ≤526 |
| 64 | ≤560 |
| 65 | ≤597 |
| 66 | ≤635 |
| 67 | ≤677 |
| 68 | ≤720 |
| 69 | ≤767 |
| 70 | ≤817 |
| 71 | ≤870 |
| 72 | ≤926 |
| 73 | ≤987 |
| 74 | ≤1051 |
| 75 | ≤1119 |
| 76 | ≤1191 |
| 77 | ≤1269 |
| 78 | ≤1351 |
| 79 | ≤1439 |
| 80 | ≤1532 |
| 81 | ≤1631 |
| 82 | ≤1737 |
| 83 | ≤1850 |
| 84 | ≤1970 |
| 85 | ≤2098 |
| 86 | ≤2234 |
| 87 | ≤2379 |
| 88 | ≤2533 |
| 89 | ≤2698 |
| 90 | ≤2873 |
| 91 | ≤3059 |
| 92 | ≤3258 |
| 93 | ≤3469 |
| 94 | ≤3694 |
| 95 | ≤3934 |
| 96 | ≤4189 |
| 97 | ≤4461 |
| 98 | ≤4751 |
| 99 | ≤5059 |
| 100 | ≤5387 |
| 101 | ≤5737 |
| 102 | ≤6109 |
| 103 | ≤6506 |
| 104 | ≤6928 |
| 105 | ≤7378 |
| 106 | ≤7857 |
| 107 | ≤8367 |
| 108 | ≤8910 |
| 109 | ≤9488 |
| 110 | ≤10104 |
| 111 | ≤10760 |
| 112 | ≤11458 |
| 113 | ≤12202 |
| 114 | ≤12994 |
| 115 | ≤13838 |
| 116 | ≤14736 |
| 117 | ≤15692 |
| 118 | ≤16711 |
| 119 | ≤17795 |
| 120 | ≤18951 |
| 121 | ≤20181 |
| 122 | ≤21491 |
| 123 | ≤22885 |
| 124 | ≤24371 |
| 125 | ≤25953 |
| 126 | ≤27638 |
| 127 | ≤29431 |
| 128 | ≤31342 |
| 129 | ≤33376 |
| 130 | ≤35543 |
| 131 | ≤37850 |
| 132 | ≤40307 |
| 133 | ≤42923 |
| 134 | ≤45709 |
| 135 | ≤48676 |
| 136 | ≤51836 |
| 137 | ≤55200 |
| 138 | ≤58784 |
| 139 | ≤62599 |
| 140 | ≤66663 |
| 141 | ≤70990 |
| 142 | ≤75598 |
| 143 | ≤80505 |
| 144 | ≤85730 |
| 145 | ≤91295 |
| 146 | ≤97221 |
| 147 | ≤103532 |
| 148 | ≤110252 |
| 149 | ≤117409 |
| 150 | ≤125030 |
| 151 | ≤133146 |
| 152 | ≤141789 |
| 153 | ≤150992 |
| 154 | ≤160793 |
| 155 | ≤171231 |
| 156 | ≤182345 |
| 157 | ≤194182 |
| 158 | ≤206786 |
| 159 | ≤220209 |
| 160 | ≤234503 |
| 161 | ≤249725 |
| 162 | ≤265935 |
| 163 | ≤283197 |
| 164 | ≤301579 |
| 165 | ≤321155 |
| 166 | ≤342002 |
| 167 | ≤364202 |
| 168 | ≤387842 |
| 169 | ≤413018 |
| 170 | ≤439827 |
| 171 | ≤468377 |
| 172 | ≤498780 |
| 173 | ≤531156 |
| 174 | ≤565634 |
| 175 | ≤602350 |
| 176 | ≤641449 |
| 177 | ≤683087 |
| 178 | ≤727427 |
| 179 | ≤774645 |
| 180 | ≤824928 |
| 181 | ≤878475 |
| 182 | ≤935498 |
| 183 | ≤996222 |
| 184 | ≤1060888 |
| 185 | ≤1129752 |
| 186 | ≤1203085 |
| 187 | ≤1281179 |
| 188 | ≤1364342 |
| 189 | ≤1452903 |
| 190 | ≤1547213 |
| 191 | ≤1647644 |
| 192 | ≤1754595 |
| 193 | ≤1868488 |
| 194 | ≤1989774 |
| 195 | ≤2118933 |
| 196 | ≤2256475 |
| 197 | ≤2402946 |
| 198 | ≤2558924 |
| 199 | ≤2725027 |
| 200 | ≤2901912 |
| 201 | ≤3090279 |
| 202 | ≤3290873 |
| 203 | ≤3504487 |
| 204 | ≤3731968 |
| 205 | ≤3974215 |
| 206 | ≤4232186 |
| 207 | ≤4506902 |
| 208 | ≤4799451 |
| 209 | ≤5110989 |
| 210 | ≤5442750 |
| 211 | ≤5796046 |
| 212 | ≤6172275 |
| 213 | ≤6572925 |
| 214 | ≤6999582 |
| 215 | ≤7453933 |
| 216 | ≤7937777 |
| 217 | ≤8453028 |
| 218 | ≤9001725 |
| 219 | ≤9586039 |
| 220 | ≤10208280 |
| 221 | ≤10870913 |
| 222 | ≤11576557 |
| 223 | ≤12328006 |
| 224 | ≤13128233 |
| 225 | ≤13980403 |
| 226 | ≤14887889 |
| 227 | ≤15854280 |
| 228 | ≤16883401 |
| 229 | ≤17979324 |
| 230 | ≤19146385 |
| 231 | ≤20389201 |
| 232 | ≤21712690 |
| 233 | ≤23122088 |
| 234 | ≤24622972 |
| 235 | ≤26221280 |
| 236 | ≤27923336 |
| 237 | ≤29735875 |
| 238 | ≤31666069 |
| 239 | ≤33721553 |
| 240 | ≤35910462 |
| 241 | ≤38241455 |
| 242 | ≤40723756 |
| 243 | ≤43367187 |
| 244 | ≤46182206 |
| 245 | ≤49179951 |
| 246 | ≤52372284 |
| 247 | ≤55771835 |
| 248 | ≤59392055 |
| 249 | ≤63247269 |
| 250 | ≤67352729 |
| 251 | ≤71724679 |
| 252 | ≤76380419 |
| 253 | ≤81338368 |
| 254 | >81338368 |
| 255 | Reserved |

In some example embodiments, the addition buffer size table may be fixed and preconfigured at the device 110. In an example embodiment, a buffer size table in the set of buffer size tables and the additional buffer size table may have same number of bits for buffer size (for example, 8 bits). Alternatively, the buffer size table (for example, Table 1 or Table 2) in the set of buffer size tables and the additional buffer size table may have different numbers of bits for buffer size. By way of example, the additional buffer size table may be used for XR services. In some example embodiments, compared with Table 1 or Table 2, the additional buffer size table may have a narrower range for minimum and maximum buffer size values and have a finer granularity. Table 3 shows an example of the additional buffer size table. It should be noted that Table 3 is only an example not limitation.

TABLE 3

| Index | BS value | Index_1 | BS value_2 | Index_3 | BS value_4 | Index_5 | BS value_6 |
|---|---|---|---|---|---|---|---|
| 0 | 10417 | 64 | ≤15665 | 128 | ≤20913 | 192 | ≤26161 |
| 1 | ≤10499 | 65 | ≤15747 | 129 | ≤20995 | 193 | ≤26243 |
| 2 | ≤10581 | 66 | ≤15829 | 130 | ≤21077 | 194 | ≤26325 |
| 3 | ≤10663 | 67 | ≤15911 | 131 | ≤21159 | 195 | ≤26407 |
| 4 | ≤10745 | 68 | ≤15993 | 132 | ≤21241 | 196 | ≤26489 |
| 5 | ≤10827 | 69 | ≤16075 | 133 | ≤21323 | 197 | ≤26571 |
| 6 | ≤10909 | 70 | ≤16157 | 134 | ≤21405 | 198 | ≤26653 |
| 7 | ≤10991 | 71 | ≤16239 | 135 | ≤21487 | 199 | ≤26735 |
| 8 | ≤11073 | 72 | ≤16321 | 136 | ≤21569 | 200 | ≤26817 |
| 9 | ≤11155 | 73 | ≤16403 | 137 | ≤21651 | 201 | ≤26899 |
| 10 | ≤11237 | 74 | ≤16485 | 138 | ≤21733 | 202 | ≤26981 |
| 11 | ≤11319 | 75 | ≤16567 | 139 | ≤21815 | 203 | ≤27063 |
| 12 | ≤11401 | 76 | ≤16649 | 140 | ≤21897 | 204 | ≤27145 |
| 13 | ≤11483 | 77 | ≤16731 | 141 | ≤21979 | 205 | ≤27227 |
| 14 | ≤11565 | 78 | ≤16813 | 142 | ≤22061 | 206 | ≤27309 |
| 15 | ≤11647 | 79 | ≤16895 | 143 | ≤22143 | 207 | ≤27391 |
| 16 | ≤11729 | 80 | ≤16977 | 144 | ≤22225 | 208 | ≤27473 |
| 17 | ≤11811 | 81 | ≤17059 | 145 | ≤22307 | 209 | ≤27555 |
| 18 | ≤11893 | 82 | ≤17141 | 146 | ≤22389 | 210 | ≤27637 |
| 19 | ≤11975 | 83 | ≤17223 | 147 | ≤22471 | 211 | ≤27719 |
| 20 | ≤12057 | 84 | ≤17305 | 148 | ≤22553 | 212 | ≤27801 |
| 21 | ≤12139 | 85 | ≤17387 | 149 | ≤22635 | 213 | ≤27883 |
| 22 | ≤12221 | 86 | ≤17469 | 150 | ≤22717 | 214 | ≤27965 |
| 23 | ≤12303 | 87 | ≤17551 | 151 | ≤22799 | 215 | ≤28047 |
| 24 | ≤12385 | 88 | ≤17633 | 152 | ≤22881 | 216 | ≤28129 |
| 25 | ≤12467 | 89 | ≤17715 | 153 | ≤22963 | 217 | ≤28211 |
| 26 | ≤12549 | 90 | ≤17797 | 154 | ≤23045 | 218 | ≤28293 |
| 27 | ≤12631 | 91 | ≤17879 | 155 | ≤23127 | 219 | ≤28375 |
| 28 | ≤12713 | 92 | ≤17961 | 156 | ≤23209 | 220 | ≤28457 |
| 29 | ≤12795 | 93 | ≤18043 | 157 | ≤23291 | 221 | ≤28539 |
| 30 | ≤12877 | 94 | ≤18125 | 158 | ≤23373 | 222 | ≤28621 |
| 31 | ≤12959 | 95 | ≤18207 | 159 | ≤23455 | 223 | ≤28703 |
| 32 | ≤13041 | 96 | ≤18289 | 160 | ≤23537 | 224 | ≤28785 |
| 33 | ≤13123 | 97 | ≤18371 | 161 | ≤23619 | 225 | ≤28867 |
| 34 | ≤13205 | 98 | ≤18453 | 162 | ≤23701 | 226 | ≤28949 |
| 35 | ≤13287 | 99 | ≤18535 | 163 | ≤23783 | 227 | ≤29031 |
| 36 | ≤13369 | 100 | ≤18617 | 164 | ≤23865 | 228 | ≤29113 |
| 37 | ≤13451 | 101 | ≤18699 | 165 | ≤23947 | 229 | ≤29195 |
| 38 | ≤13533 | 102 | ≤18781 | 166 | ≤24029 | 230 | ≤29277 |
| 39 | ≤13615 | 103 | ≤18863 | 167 | ≤24111 | 231 | ≤29359 |
| 40 | ≤13697 | 104 | ≤18945 | 168 | ≤24193 | 232 | ≤29441 |
| 41 | ≤13779 | 105 | ≤19027 | 169 | ≤24275 | 233 | ≤29523 |
| 42 | ≤13861 | 106 | ≤19109 | 170 | ≤24357 | 234 | ≤29605 |
| 43 | ≤13943 | 107 | ≤19191 | 171 | ≤24439 | 235 | ≤29687 |
| 44 | ≤14025 | 108 | ≤19273 | 172 | ≤24521 | 236 | ≤29769 |
| 45 | ≤14107 | 109 | ≤19355 | 173 | ≤24603 | 237 | ≤29851 |
| 46 | ≤14189 | 110 | ≤19437 | 174 | ≤24685 | 238 | ≤29933 |
| 47 | ≤14271 | 111 | ≤19519 | 175 | ≤24767 | 239 | ≤30015 |
| 48 | ≤14353 | 112 | ≤19601 | 176 | ≤24849 | 240 | ≤30097 |
| 49 | ≤14435 | 113 | ≤19683 | 177 | ≤24931 | 241 | ≤30179 |
| 50 | ≤14517 | 114 | ≤19765 | 178 | ≤25013 | 242 | ≤30261 |
| 51 | ≤14599 | 115 | ≤19847 | 179 | ≤25095 | 243 | ≤30343 |
| 52 | ≤14681 | 116 | ≤19929 | 180 | ≤25177 | 244 | ≤30425 |
| 53 | ≤14763 | 117 | ≤20011 | 181 | ≤25259 | 245 | ≤30507 |
| 54 | ≤14845 | 118 | ≤20093 | 182 | ≤25341 | 246 | ≤30589 |
| 55 | ≤14927 | 119 | ≤20175 | 183 | ≤25423 | 247 | ≤30671 |
| 56 | ≤15009 | 120 | ≤20257 | 184 | ≤25505 | 248 | ≤30753 |
| 57 | ≤15091 | 121 | ≤20339 | 185 | ≤25587 | 249 | ≤30835 |
| 58 | ≤15173 | 122 | ≤20421 | 186 | ≤25669 | 250 | ≤30917 |
| 59 | ≤15255 | 123 | ≤20503 | 187 | ≤25751 | 251 | ≤30999 |
| 60 | ≤15337 | 124 | ≤20585 | 188 | ≤25833 | 252 | ≤31081 |
| 61 | ≤15419 | 125 | ≤20667 | 189 | ≤25915 | 253 | ≤31163 |
| 62 | ≤15501 | 126 | ≤20749 | 190 | ≤25997 | 254 | ≤31245 |
| 63 | ≤15583 | 127 | ≤20831 | 191 | ≤26079 | 255 | ≤31327 |

The device 110 determines (2030) which buffer size table (also referred to as “target buffer size table”) to be used for a buffer status report of the at least one logical channel group based on a type of the buffer status report. The target buffer size table may be the additional buffer size table or may be determined from the set of buffer size tables based on the type of the buffer status report. By way of example, if a buffer size of the buffer status report is out of range of the additional buffer size table, the device 110 may determine to fall back to use one of the first set of buffer size tables (for example, Table 1 or Table 2). For example, if the amount of the buffered data is 10000 bytes, it means that the buffer size is out of the range of the additional buffer size table. In this case, the device 110 may determine to fall back to use Table 1 or Table 2. Alternatively, if the amount of the buffered data is 34000 bytes, it means that the buffer size is out of the range of the additional buffer size table. In this case, the device 110 may determine to fall back to use Table 2. In some example embodiments, as mentioned above, the first set of buffer size tables includes a 5-bit buffer size table and an 8-bit buffer size table, if the target buffer size table is determined from the first set of buffer size tables, the device 110 may determine the target buffer size table to be the 5-bit buffer size table or the 8-bit buffer size table based on the type of buffer status report.

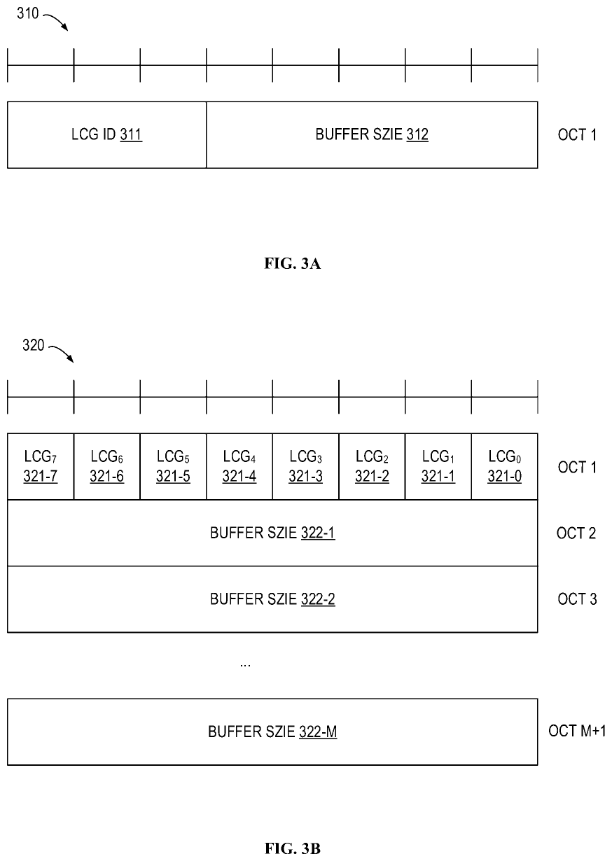

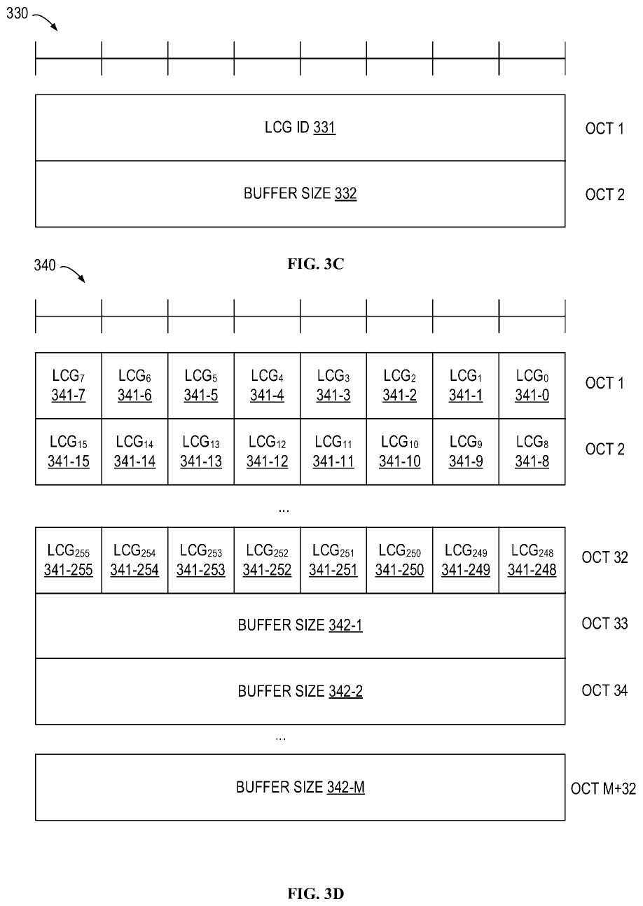

In some example embodiments, the buffer status report may be a short buffer status report. Alternatively, the buffer status report may be a short truncated buffer status report. FIG. 3A illustrates a schematic diagram of a MAC CE 310 for short buffer status report or short truncated buffer status report. As shown in FIG. 3A, the LCG ID field 311 may identity the group of logical channel(s) of which buffer status is being report. The length of the LCG ID field 311 may be 3 bits. The buffer size field 312 may identity the total amount of data available across all logical channels of a logical channel group after a MAC protocol data unit (PDU) has been built. The amount of data may be indicated in number of bytes. The size of the radio logic channel (RLC) and MAC headers may not be considered in the buffer size computation. The length of the buffer size field 312 may be 5 bits. The value for the 5-bit buffer size field may be shown in Table 1 above.

In some other example embodiments, the buffer status report may be a long buffer status report. Alternatively, the buffer status report may be a long truncated buffer status report. FIG. 3B illustrates a schematic diagram of a MAC CE 320 for long buffer status report or long truncated buffer status report. As shown in FIG. 3B, the LCGᵢ field 321-i (for example, i may be in a range from 0 to 7) may indicate a presence of the buffer size field for the logical channel group i. For example, the LCGᵢ field 321-i set to 1 indicates that the buffer size field 322-i for the logical channel group i is reported. The LCGᵢ field set to 0 indicates that the buffer size field 322-i for the logical channel group i is not reported. For the long truncated BSR format, the LCGᵢ field 321-i may indicate whether logical channel group i has data available. For example, the LCGᵢ field the LCGᵢ field 321-i set to 1 indicates that logical channel group i has data available. The LCGᵢ field set to 0 indicates that logical channel group i does not have data available. The buffer size field 322-i (for example, i may be in a range from 0 to m and m may be not greater than 7) may identity the total amount of data available across all logical channels of a logical channel group after a MAC protocol data unit (PDU) has been built. The amount of data may be indicated in number of bytes. The size of the radio logic channel (RLC) and MAC headers may not be considered in the buffer size computation. The length of the buffer size field 322-i may be 8 bits. The value for the 8-bit buffer size field may be shown in Table 2 above. For the long buffer status report format and the long truncated buffer status report format, the buffer size fields may be included in ascending order based on the LCGᵢ. For the long truncated buffer status report format the number of buffer size fields included may be maximized, while not exceeding the number of padding bits.

In a yet example embodiment, the buffer status report may be an extend short buffer status report. Alternatively, the buffer status report may be an extend short truncated buffer status report. FIG. 3C illustrates a schematic diagram of a MAC CE 330 for extended short buffer status report or extended short truncated buffer status report. As shown in FIG. 3C, the LCG ID field 331 may identity the group of logical channel(s) of which buffer status is being report. The length of the LCG ID field 331 may be 8 bits. The buffer size field 332 may identity the total amount of data available across all logical channels of a logical channel group. The length of the buffer size field 322 may be 8 bits. The value for the 8-bit buffer size field may be shown in Table 2 above.

In some other example embodiments, the buffer status report may be an extended long buffer status report. Alternatively, the buffer status report may be an extended long truncated buffer status report. FIG. 3D illustrates a schematic diagram of a MAC CE 340 for extended long buffer status report or extended long truncated buffer status report. As shown in FIG. 3D, the LCG; field 341-i (for example, i may be in a range from 0 to 255) may indicate a presence of the buffer size field for the logical channel group i. The buffer size field 342-i (for example, i may be in a range from 0 to m and m may be not greater than 255) may identity the total amount of data available across all logical channels of a logical channel group. The amount of data may be indicated in number of bytes. The length of the buffer size field 342-i may be 8 bits. The value for the 8-bit buffer size field may be shown in Table 2 above.

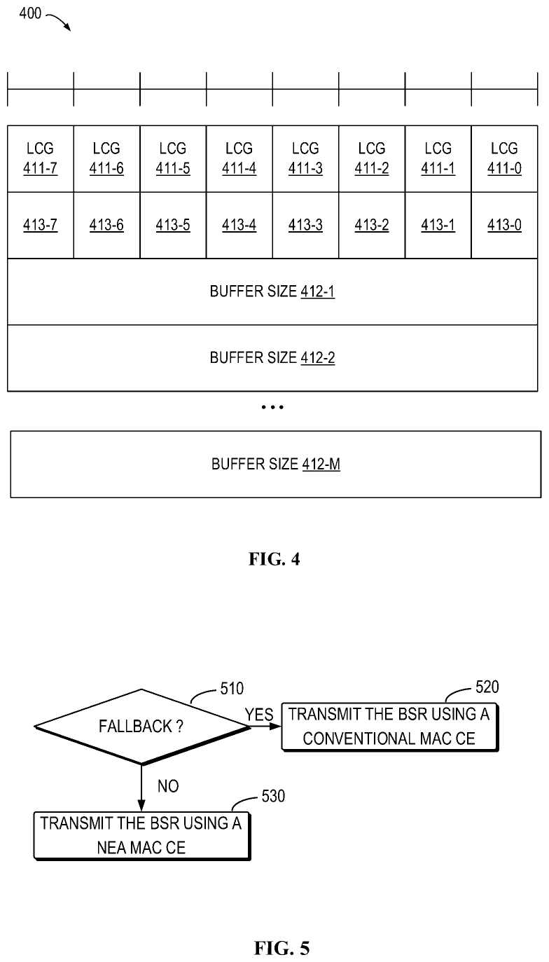

In an example embodiment, the buffer status report may be a further long buffer status report. Alternatively, the buffer status report may be a further long truncated buffer status report. FIG. 4 illustrates a schematic diagram of a MAC CE 400 for the further long buffer status report or further long truncated buffer status report. As shown in FIG. 4, the LCGᵢ field 411-i (for example, i may be in a range from 0 to 7) may indicate a presence of the buffer size field for the logical channel group i. The buffer size field 412-i (for example, i may be in a range from 0 to m and m may be not greater than 7) may identity the total amount of data available across all logical channels of a logical channel group. The amount of data may be indicated in number of bytes. The length of the buffer size field 412-i may be 8 bits. The value for the 8-bit buffer size field may be shown in Table 2 above. The fallback indication field 413-i (for example, i may be in a range from 0 to 7) may indicate whether a fallback happens for the logical channel group i. For example, if the fallback indication field 413-i set to 0, it indicates a usage of the configuration, i.e., there is no fall back. If the fallback indication field 413-i set to 1, it indicates that the fallback happens for the logical channel group i.

In some example embodiments, there may be three BRS types according to a timing of transmitting the buffer status report, i.e., regular BSR, periodic BSR, padding BSR. Regular BSR may be sent when new data arrives in UL buffer and the new data has higher priority than the one already waiting in the buffer. Periodic BSR may be sent with the predefined periodicity. The periodicity may be defined by network and get informed to the device 110 by RRC message.

The device 110 transmits (2040) to the device 120 a buffer status report for the at least one logical channel group that is based on the target buffer size report. In other words, the device 120 may receive from the device 110 the buffer status report that is based on the target buffer size table.

In some example embodiments, the device 110 may determine that the buffer status report is a padding buffer status report. The device 110 may also determine that the type of buffer status report may be the short buffer status report or the short truncated buffer status report. In an example embodiment, the device 110 may determine a space for padding buffer status report payload. For example, if there is one byte space for the padding buffer status report payload, the device 110 may transmit the buffer status report that is based on a buffer size table (for example, 5-bit buffer size table) from the set of buffer size tables. For example, the buffer size field in the buffer status report may be determined based on Table 1 above. By way of example, if the amount of buffered data is 250, the buffer size filed may include the index 11. In this case, the buffer status report may be the short buffer status report or the short truncated buffer status report. For example, the buffer status report may be transmitted using the MAC CE 310 as shown in FIG. 3A. That is, if there is only one byte left for padding buffer status payload, the short or short truncated buffer status report with the 5 bits buffer size table may be reported for the LCG even if the LCG is configured to use the addition buffer size table with 8-bit. In other words, only long new buffer status report and long truncated new buffer status report may be defined with the additional buffer size table. As a result, fallback to the buffer size table (for example, Table 1 or Table 2) for a LCG configured to use the addition buffer size table may not only occur when the buffer size is out of range of the addition buffer size table, and the 5 bits buffer size table can be used as well in case short/short truncated BSR is reported for padding BSR.

Alternatively, the device 120 may transmit a configuration of a 5-bit short buffer status report or a short truncated buffer status report to the device 110. In other words, the device 110 may receive the configuration of the 5-bit short buffer status report or the short truncated buffer status report from the device 120. For example, such configuration may be used for XR services or other services. The configuration of the 5-bit short buffer status report or the short truncated buffer status report may be transmitted via one of: a radio resource control (RRC) signaling, a MAC CE or downlink control information (DCI). By way of example, if the configuration of the 5-bit short buffer status report or the short truncated buffer status report is configured with the RRC signaling, it can be included in a buffer status report configuration message. That is, a configurable fallback may be applied, which may be implemented by an RRC configuration in the buffer status report configuration (BSR_CONFIG) message during a LCG configuration.

In some example embodiments, the device 110 may determine that the type of buffer status report is the padding buffer status report. In an example embodiment, the device 110 may transmit the buffer status report to the device 120, when padding bits for the buffer status report are available. In other words, the device 120 may receive the buffer status report from the device 110, when padding bits for the buffer status report are available. For example, in an example, the long truncated buffers status report MAC CE may prioritize LCGs configured with the additional buffer size table in the reporting and ordering of the buffer size fields in the MAC CE. For example, if the XR traffic is the critical one, this allows for better capacity optimization decisions at the device 120. as the buffer status report for XR may always be sent when padding bit are available. The configuration of the one or more logical channel groups may indicate the buffer status report is transmitted when padding bits for the buffer status report are available.

Alternatively, prioritization rules based on priority of LCG may still apply regardless of whether the buffer size table in the set of buffer size tables or the additional buffer size table is used for a logical channel group. In an example embodiment, if a first buffer status report for a first logical channel group using the set of buffer size tables and a second buffer status report for a second logical channel group using the additional buffer size table are to be reported, the device 110 may transmit the first buffer status report and the second buffer status report in different MAC CEs to the device 120. The device 120 may receive the first buffer status report and the second buffer status report in different MAC CEs from the device 110. That is to say, logical channel groups using the buffer size table (for example, Table 1 or Table 2) and the additional buffer size table may be reported separately in different MAC CEs. It may be indicated as truncated MAC CE as long as there is a LCG with data not reported even if the MAC CE already included all the LCGs using the corresponding buffer size table.

Alternatively, the device 110 may transmit the first buffer status report and the second buffer status report in a same MAC CE to the device 120. This MAC CE may include an indication indicating which buffer size table is used to. In other words, the device 120 may receive the first buffer status report and the second buffer status report in the same MAC CE from the device 110.

In another example embodiment, the device 110 may determine that the buffer status report is the padding buffer status report. In this case, if at least one of logical channel groups to be reported uses the additional buffer size table, the device 110 may transmit a padding buffer status report for the logical channel groups based on the buffer size table in the set of buffer size tables to the device 120. In other words, the device 120 may receive the padding buffer status report for the logical channel groups based on the buffer size table (for example, Table 1 or Table 2) in the set of buffer size tables from the device 110. By way of example, in some cases, as long as a logical channel group uses the buffer size table (for example, Table 1 or Table 2) in the set of buffer size tables, the padding buffer status report for all logical channel groups may use the buffer size table in the set of buffer size tables. For example, based on the prioritization rule, when the LCGs to be reported include LCGs using the additional buffer size table and LCGs not using the additional buffer size table, a padding buffer status report may always use the buffer size table for all the LCGs reported. Otherwise, if only one buffer size table is used for all the LCGs reported, either the buffer size table or the additional buffer size table may be used.

In a yet example embodiment, the device 110 may determine that the buffer status report is the regular buffer status report. Alternatively, the device 110 may determine that the buffer status report is the periodic buffer status report. In these cases, the device 110 may determine the target buffer size table from the set of buffer size tables. The number of bits for buffer size in the target buffer size table may be same as that of the additional buffer size table. For example, if the additional buffer size table may be a 5-bit buffer size table, the target buffer size table may also be 5-bit buffer size table. Alternatively, if the additional buffer size table may be an 8-bit buffer size table, the target buffer size table may also be 8-bit buffer size table.

In some example embodiments, the device 110 may determine that the type of buffer status report may be the long buffer status report or the long truncated buffer status report. In an example embodiment, as shown in FIG. 5, at block 510, the device 110 may determine whether the at least one logical channel group in the one or more logical channel groups uses a further buffer size table (for example, the 8-bit buffer size table) from the set of buffer size tables. In some example embodiments, the device 110 may determine that the at least one logical channel group in the one or more logical channel groups falls back to use the buffer size table in the set of buffer size tables. For example, the device 110 may determine that the at least one logical channel group falls back to use the Table 2.

In an example embodiment, if the at least one logical channel group falls back to use the buffer size table of the set of buffer size tables, at block 520, the device 110 may transmit the buffer status report for the one or more logical channel groups using a convention MAC CE. For example, the buffer status report may be transmitted using the MAC CE 320 shown in FIG. 3B. The buffer status report for the one or more logical channel groups may be transmitted based on the buffer size table of the set of buffer size tables. In other words, the device 120 may receive the buffer status report for the one or more logical channel groups based on the buffer size table of the set of buffer size tables from the device 110. In this case, the buffer status report may be the long buffer status report or the long truncated buffer status report.

Alternatively, if none of the at least one logical channel group falls back to the buffer size table in the set of buffer size tables, at block 530, the 110 may transmit to the device 120 the buffer status report for the at least one logical channel group using the new MAC CE. For example, the buffer status report may be transmitted using the MAC CE 400 in FIG. 4. The buffer status report for the one or more logical channel groups may be transmitted based on the additional buffer size table. In other words, the device 120 may receive the buffer status report for the at least one logical channel group based on the additional buffer size table (for example, Table 3) from the device 110. For example, the buffer size field in the buffer status report may be determined based on the additional buffer size table. In this case, the buffer status report may be the further long truncated buffer status report or the further long buffer status report. Further, the device 110 may determine that another logical channel group in the one or more logical channel groups uses the set of buffer size tables (for example, using the 5-bit buffer size table or the 8-bit buffer size table). In this case, the device 110 may transmit to the device 120, another buffer status report for the other logical channel group based on the set of buffer size tables (for example, Table 1 or Table 2). For example, the other buffer status report may be determined based on the buffer size table.

In some example embodiments, the device 110 may transmit to the device 120 the buffer status report in a MAC CE format that includes a field indicating whether the at least one logical channel group uses the target buffer size table determined from the set buffer size tables. In other words, the device 120 may receive the buffer status report in the MAC CE format from the device 110. For example, the buffer status report may be transmitted in the MAC CE 410 as shown in FIG. 4. That is, the MAC CE may include a field indicating whether there is a fallback from the addition buffer size table to the set of buffer size tables. As shown in FIG. 4, the MAC CE 410 includes a field 431 indicating whether there is a fallback from the additional buffer size table to the buffer size table for the one or more logical channel groups.

Alternatively, the device 110 may transmit the buffer status report that includes a logical channel identity indicating whether the additional buffer size table is used to the device 120. In other words, the device 120 may receive the buffer status report including the logical channel identity from the device 110. For example, the logical channel identity (LCID) in a sub-header of the MAC CE (for example, the MAC CE 310, MAC CE 320, MAC CE 330, or MAC CE 340) may be used to indicate that additional buffer size table may be used. In this case, the LCID may be a new defined value.

Example embodiments of selecting a MAC CE format for buffer status report are described below.

The device 110 may be configured with one LCG using the additional buffer size table and the LCG with data buffered to be reported. In this case, when reporting short BSR or short truncated BSR with only one byte space for BSR payload, the device 110 may report the BSR using the 5-bit buffer size table. Alternatively, the device 110 may report a long BSR or a long truncated BSR or a long new truncated BSR. In this case, if the LCG using XR BSR table has done fallback, the device 110 may transmit the BSR using the MAC CE 320. Alternatively, if the LCG using XR BSR table has not done fallback, the device 110 may transmit the BSR using the MAC CE 410 to distinguish the BSR. Further, other LCGs that use buffer size tables can still report BS as the device 120 knows which LCGs use which tables.

The device 110 may be configured with more than one LCGs using the additional buffer size table and with data buffered. In this case, when reporting a short BSR or a short truncated BSR with only one byte space for BSR payload, the device 110 may report the BSR using the 5-bit buffer size table. Alternatively, the device 110 may report a long BSR or a long truncated BSR or a long new truncated BSR. In this case, if at least one of the LCGs using XR BSR table has done fallback, the device 110 may transmit the BSR using the MAC CE 320 for all LCGs regardless that some XR BSR LCGs might not have done a fallback. Alternatively, if none of the LCGs using XR BSR table has done fallback, the device 110 may transmit the BSR using the MAC CE 410 to distinguish the BSR. Further, other LCGs that use buffer size tables can still report BS as the device 120 knows which LCGs use which tables.

Table 4 below shows examples for MAC for some embodiments assuming long new BSR and long truncated new BSR are the new MAC CEs for LCGs with the new BS table and they are reported separately from the conventional MAC CEs.

TABLE 4
For Regular and Periodic BSR, the MAC entity for which logicalChannelGroup-IAB-Ext is
not configured by upper layers shall:

| | |
|---|---|
| 1> | if more than one LCG not configured with newBSTable has data available for |
| | transmission when the MAC PDU containing the BSR is to be built: |

| | |
|---|---|
| 2> | report Long BSR for all LCGs which have data available for transmission. |

| | |
|---|---|
| 1> | else if only one LCG not configured with newBSTable has data available for |
| | transmission when the MAC PDU containing the BSR is to be built: |

| | |
|---|---|
| 2> | report Short BSR. |

| | |
|---|---|
| 1> | if at least one LCG configured with newBSTable has data available for transmission |
| | when the MAC PDU containing the BSR is to be built: |

| | |
|---|---|
| 2> | report Long New BSR for all LCGs conifgured with newBSTable which have data |
| | available for transmission. |

For Padding BSR, the MAC entity for which logicalChannelGroup-IAB-Ext is not
configured by upper layers shall:

| | |
|---|---|
| 1> | if the number of padding bits is equal to or larger than the size of the Short BSR plus |
| | its subheader but smaller than the size of the Long BSR plus its subheader and the |
| | size of Long New BSR plus its subheader: |

| | |
|---|---|
| 2> | if more than one LCG has data available for transmission when the BSR is to be |
| | built: |

| | |
|---|---|
| 3> | if the number of padding bits is equal to the size of the Short BSR plus its |
| | subheader: |

| | |
|---|---|
| 4> | report Short Truncated BSR of the LCG with the highest priority logical |
| | channel with data available for transmission. |

| | |
|---|---|
| 3> | else: |

| | |
|---|---|
| 4> | report Long Truncated New BSR for all LCGs configured with newBSTable |
| | with the logical channels if any having data available for transmission |
| | following a decreasing order of the highest priority logical channel (with or |
| | without data available for transmission) in each of these LCG(s), and in case |
| | of equal priority, in increasing order of LCGID. |
| 4> | if still space left, report Long Truncated BSR of the LCG(s) not configured |
| | with newBSTable with the logical channels if any having data available for |
| | transmission following a decreasing order of the highest priority logical |
| | channel (with or without data available for transmission) in each of these |
| | LCG(s), and in case of equal priority, in increasing order of LCGID. |

| | |
|---|---|
| 2> | else: |

| | |
|---|---|
| 3> | report Short BSR. |

| | |
|---|---|
| 1> | else if the number of padding bits is equal to or larger than the size of the Long BSR |
| | plus its subheader and the size of Long New BSR plus its subheader: |

| | |
|---|---|
| 2> | report Long BSR for all LCGs not configured with newBSTable which have data |
| | available for transmission if any. |
| 2> | report Long New BSR for all LCGs configured with newBSTable which have data |
| | available for transmission if any. |

According to embodiments described above, conventional short BSR can still be reported for LCG using 8 bits new buffer size table, when there is one byte payload available which provide more information than reporting only the 8 bits bitmap indicating there is one LCG with data but without enough space to indicate buffer size information. Further, optional future 5-bit buffer size tables can be provided as fallback via optional RRC configuration. When BSR for LCG using conventional buffer size table and new buffer size table are reported in separate BSR MAC CE, prioritization rules may be defined when both cannot be included. In addition, it also simplifies the padding BSR procedure when there is data buffered for LCGs both with and without new buffer size table configured/used.

### Example Methods

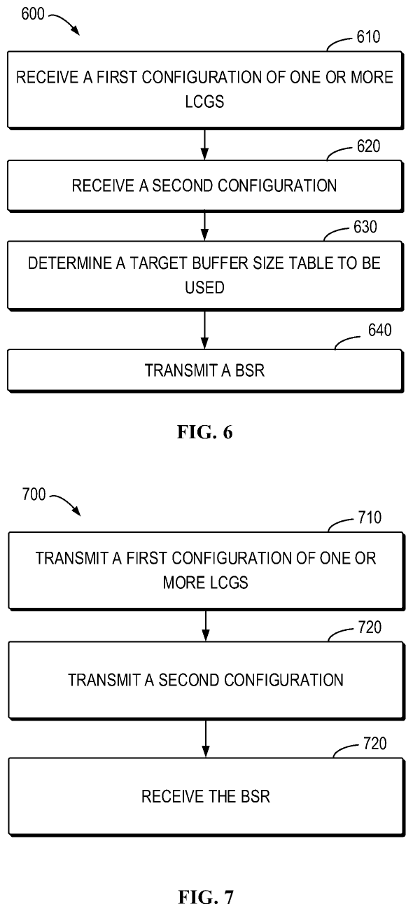

FIG. 6 shows a flowchart of an example method 600 implemented at a first device in accordance with some example embodiments of the present disclosure. For the purpose of discussion, the method 600 will be described from the perspective of the device 110 in FIG. 1.

At block 610, the device 110 receives from the device 120, a first configuration of one or more logical channel groups.

At block 620, the device 110 receives from the device 120, a second configuration indicating whether at least one logical channel group of the one or more logical channel groups is able to use a second buffer size table in addition to a first set of buffer size tables.

At block 630, the device 110 determines, from the first set buffer size tables and the second buffer size table, a target buffer size table to be used for a buffer status report of the at least one logical channel group based on a type of buffer status report.

At block 640, the device 110 transmits to the device 120, the buffer status report that is based on the target buffer size table. In some example embodiments, the type of buffer status report includes at least one of: a padding buffer status report, a regular buffer status report, a periodic buffer status report, a short buffer status report, a short truncated buffer status report, a long buffer status report, a long truncated buffer status report, a padding buffer status report, a further long buffer status report which is different from the long buffer status report, or a further long truncated buffer status report which is different from the long truncated BSR.

In some example embodiments, the device 110 may determine that the buffer status report is the padding buffer status report. If the type of buffer status report is the short buffer status report or the short truncated buffer status report, the device 110 may determine that a space for padding buffer status report payload. In this case, if there is one byte space for the buffer status report payload, the device 110 may transmit to the device 120, the buffer status report that is based on a buffer size table from the first set buffer size tables.

In some example embodiments, if the type of buffer status report is the long buffer status report or the long truncated buffer status report, the device 110 may determine whether the at least one logical channel group uses a further buffer size table from the first set buffer size tables. In this case, if the at least one logical channel group uses the further buffer size table, the device 110 may transmit to the device 120 the buffer status report based on the further buffer size table. The buffer status report may be one of: the long buffer status report or the long truncated buffer status report.

In some example embodiments, the device 110 may determine that none of the at least one logical channel group uses the first set buffer size tables. In this case, the device 110 may transmit to the device 120, the buffer status report that is based on the second buffer size table. The buffer status report may be the further long truncated buffer status report or the further long buffer status report.

In some example embodiments, the device 110 may determine that another logical channel group in the one or more logical channel groups uses the first set buffer size tables. In this case, the device 110 may transmit to the device 120, another buffer status report for the other logical channel group based on the first set buffer size tables.

In some example embodiments, the device 110 may transmit to the device 120, the buffer status report in a medium access control (MAC) control element (CE) format that includes a field indicating whether the at least one logical channel group uses the target buffer size table from determined the first set buffer size tables. In some example embodiments, the device 110 may transmit to the device 120, the buffer status report that includes a logical channel identity indicating whether the second buffer size table is used.

In some example embodiments, the device 110 may receive from the device 120 a configuration of a 5-bit short buffer status report or a short truncated buffer status report via one of: a radio resource control signaling, a MAC CE, or downlinking control information. In some example embodiments, if the configuration of the buffer status report is configured via the radio resource control signaling, the configuration of the buffer status is included in a buffer status report configuration message. In some example embodiments, if the type of buffer status report is the padding buffer status report, the device 110 may transmit to the device 120 the buffer status report when padding bits for the buffer status report are available.

In some example embodiments, if a first buffer status report for a first logical channel group using first set of buffer size tables and a second buffer status report for a second logical channel group using the second buffer size table are to be reported, the device 110 may transmit to the device 120 the first buffer status report and the second buffer status report in different MAC CEs. In some example embodiments, if a first buffer status report for a first logical channel group using the first set of buffer size tables and a second buffer status report for a second logical channel group using the second buffer size table are to be reported, the device 110 may transmit to the device 120 the first buffer status report and the second buffer status report in a same MAC CE that includes an indication indicating which buffer size table is used.

In some example embodiments, the device 110 may determine that the buffer status report is the padding buffer status report. If at least one of logical channel groups to be reported uses the second buffer size table, the device 110 may transmit to the device 120 the buffer status report for all of the logical channel groups based on the target buffer size table determined from the first set of buffer size tables.

In some example embodiments, if the buffer status report is the regular buffer status report or the periodic buffer status report, the device 110 may determine the target buffer size table from the first set of buffer size tables. The number of bits for buffer size in the target buffer size table may be same as that of the second buffer size table. In some example embodiments, the device 110 may transmit to the device 120 the buffer status report based on the target buffer size table.

In some example embodiments, the first set of buffer size tables includes a 5-bit buffer size table and an 8-bit buffer size table. In some example embodiments, if the target buffer size table is determined from the first set of buffer size tables, the device 110 may determine the target buffer size table to be the 5-bit buffer size table or the 8-bit buffer size table based on the type of buffer status report.

FIG. 7 shows a flowchart of an example method 700 implemented at a device in accordance with some example embodiments of the present disclosure. For the purpose of discussion, the method 700 will be described from the perspective of the device 120 in FIG. 1.

At block 710, the device 120 transmits to the device 110 a first configuration of one or more logical channel groups.

At block 720, the device 120 transmits to the device 110 a second configuration indicating whether at least one logical channel group of the one or more logical channel groups is able to use a second buffer size table in addition to a first set of buffer size tables.

At block 730, the device 120 receives from the device 110 a buffer status report for the at least one logical channel group that is based on a target buffer size table, wherein the target buffer size table is determined from the first set of buffer size tables and the second buffer size table based on a type of buffer status report. In some example embodiments, the type of buffer status report includes at least one of: a padding buffer status report, a regular buffer status report, a periodic buffer status report, a short buffer status report, a short truncated buffer status report, a long buffer status report, a long truncated buffer status report, a further long buffer status report which is different from the long buffer status report, or a further long truncated buffer status report which is different from the long truncated BSR.

In some example embodiments, if the buffer status report is the padding buffer status report and the type of buffer status report is the short buffer status report or the short truncated buffer status report and there is one byte space for buffer status report payload, the device 120 may receive from the device 110 the buffer status report that is based on a buffer size table from the first set of buffer size tables. The buffer status report may be the short buffer status report or the short truncated buffer status report.

In some example embodiments, if the type of buffer status report is the long buffer status report or the long truncated buffer status report and the at least one logical channel group uses a further buffer size table from the first set of buffer size tables, the device 120 may receive from the device 110 the buffer status report for the one or more logical channel groups based on the further buffer size table from the first set of buffer size tables. The buffer status report may be one of: the long buffer status report or the long truncated buffer status report.

In some example embodiments, if none of at least one logical channel group uses the first set of buffer size tables, the device 120 may receive from the device 110 the buffer status report for the at least one logical channel group that is based on the second buffer size table. The buffer status report may be the further long truncated buffer status report or the further long buffer status report. In some example embodiments, if another logical channel group in the one or more logical channel groups uses the first set of buffer size tables, the device 120 may receive from the device 110 another buffer status report for the other logical channel group based on the first buffer size table.

In some example embodiments, the device 120 may receive from the device 110 the buffer status report in a medium access control (MAC) control element (CE) format that includes a field indicating whether the at least one logical channel group uses the target buffer size table from the first set buffer size tables. In some example embodiments, the device 120 may receive from the device 110 the buffer status report that includes a logical channel identity indicating whether the second buffer size table is used.

In some example embodiments, the device 120 may transmit to the device 110 a configuration of a 5-bit short buffer status report or a short truncated buffer status report via one of: a radio resource control signaling, a MAC CE, or downlinking control information. In some example embodiments, if the configuration of the buffer status report is configured via the radio resource control signaling, the configuration of the buffer status is included in a buffer status report configuration message.

In some example embodiments, if the buffer status report is the padding buffer status report, the device 120 may receive from the device 110 the buffer status report when padding bits for the buffer status report are available. In some example embodiments, if a first buffer status report for a first logical channel group using the first set of buffer size tables and a second buffer status report for a second logical channel group using the second buffer size table are to be reported, the device 120 may receive from the device 110 the first buffer status report and the second buffer status report in different MAC CEs. In some example embodiments, if a first buffer status report for a first logical channel group using the first set of buffer size tables and a second buffer status report for a second logical channel group using the second buffer size table are to be reported, the device 120 may receive from the device 110 the first buffer status report and the second buffer status report in a same MAC CE that includes an indication indicating which buffer size table is used.

In some example embodiments, if the buffer status report is the padding buffer status report and at least one of logical channel groups to be reported uses a second logical channel group using the second buffer size table, the device 120 may receive from the device 110 the padding buffer status report for the logical channel groups based on the target buffer size table determined from the first set of buffer size tables.

In some example embodiments, if the buffer status report is the regular buffer status report or the periodic buffer status report, the device 120 may receive from the device 110 the buffer status report based on the target buffer size table determined from the first set of buffer size tables. The number of bits for buffer size in the target buffer size table may be same as that of the second buffer size table.

### Example Apparatus, Device and Medium

In some example embodiments, a first apparatus capable of performing any of the method 600 (for example, the device 110 in FIG. 1) may comprise means for performing the respective operations of the method 600. The means may be implemented in any suitable form. For example, the means may be implemented in a circuitry or software module. The first apparatus may be implemented as or included in the device 110 in FIG. 1.

In some example embodiments, the first apparatus comprises means for receiving, from a second apparatus, a first configuration of one or more logical channel groups; means for receiving, from the second apparatus, a second configuration indicating whether at least one logical channel group of the one or more logical channel groups is able to use a second buffer size table in addition to a first set of buffer size tables; means for determining, from the first set of buffer size tables and the second buffer size table, a target buffer size table to be used for a buffer status report of the at least one logical channel group based on a type of buffer status report; and means for transmitting, to the second apparatus, the buffer status report that is based on the target buffer size table.

In some example embodiments, the type of buffer status report comprises at least one of: a padding buffer status report, a regular buffer status report, a periodic buffer status report, a short buffer status report, a short truncated buffer status report, a long buffer status report, a long truncated buffer status report, a further long buffer status report which is different from the long buffer status report, or a further long truncated buffer status report which is different from the long truncated buffer status report.

In some example embodiments, the first apparatus further comprises: means for determining that the buffer status report is the padding buffer status report; means for in an accordance with a determination that the type of buffer status report is the short buffer status report or the short truncated buffer status report, determining a space for padding buffer status report payload; and means for in accordance with a determination that there is one byte space for the buffer status report payload, transmitting to the second apparatus, the buffer status report that is based on a buffer size table from the first set of buffer size tables.

In some example embodiments, the first apparatus further comprises: means for in accordance with a determination that the type of buffer status report is the long buffer status report or the long truncated buffer status report, determining that whether the at least one logical channel group uses a further buffer size table from the first set of buffer size tables; and means for in accordance with a determination that the at least one logical channel group uses the further buffer size table, transmitting to the second apparatus, the buffer status report that is based on the further buffer size table.

In some example embodiments, the first apparatus further comprises: means for determining that none of the at least one logical channel group uses first set buffer size tables; and means for transmitting, to the second apparatus, the buffer status report that is based on the second buffer size table, wherein the buffer status report is the further long truncated buffer status report or the further long buffer status report.

In some example embodiments, the first apparatus further comprises: means for determining that another logical channel group in the one or more logical channel groups uses the first set buffer size tables; and means for transmitting, to the second apparatus, another buffer status report for the other logical channel group based on the first set buffer size tables.

In some example embodiments, the first apparatus further comprises: means for transmitting, to the second apparatus, the buffer status report in a medium access control (MAC) control element (CE) format that includes a field indicating whether the at least one logical channel group uses the target buffer size table from determined the first set buffer size tables.

In some example embodiments, the first apparatus further comprises: means for transmitting, to the second apparatus, the buffer status report that comprises a logical channel identity indicating whether the second buffer size table is used.

In some example embodiments, the first apparatus further comprises: means for receiving, from the second apparatus, a configuration of a 5-bit short buffer status report or a short truncated buffer status report via one of: a radio resource control signaling, a MAC CE, or means for downlinking control information.

In some example embodiments, in accordance with a determination that the configuration of the buffer status report is configured via the radio resource control signaling, the configuration of the buffer status is included in a buffer status report configuration message.

In some example embodiments, the first apparatus further comprises: means for in accordance with a determination that the type of buffer status report is the padding buffer status report, transmitting, to the second apparatus, the buffer status when padding bits for the buffer status report are available.

In some example embodiments, the first apparatus further comprises: means for in accordance with a determination that a first buffer status report for a first logical channel group using the first set of buffer size tables and a second buffer status report for a second logical channel group using the second buffer size table are to be reported, transmitting, to the second apparatus, the first buffer status report and the second buffer status report in different MAC CEs.

In some example embodiments, the first apparatus further comprises: means for in accordance with a determination that a first buffer status report for a first logical channel group using the first set of buffer size tables and a second buffer status report for a second logical channel group using the second buffer size table are to be reported, transmitting, to the second apparatus, the first buffer status report and the second buffer status report in a same MAC CE that comprises an indication indicating which buffer size table is used.

In some example embodiments, the first apparatus further comprises: means for determining that the buffer status report is the padding buffer status report; means in accordance with a determination that at least one of logical channel groups to be reported uses the second buffer size table, transmitting, to the second apparatus, the buffer status report for the logical channel groups based on the target buffer size table determined from the first set of buffer size tables.

In some example embodiments, the first apparatus further comprises: in accordance with a determination that the buffer status report is the regular buffer status report or the periodic buffer status report, determining the target buffer size table from the first set of buffer size tables, wherein the number of bits for buffer size in the target buffer size table is same as that of the second buffer size table; and transmitting to the second apparatus the buffer status report based on the target buffer size table.

In some example embodiments, the first set of buffer size tables includes a 5-bit buffer size table and an 8-bit buffer size table. some example embodiments, the first apparatus further comprises: in accordance with a determination that the target buffer size table is determined from the first set of buffer size tables, determining the target buffer size table to be the 5-bit buffer size table or the 8-bit buffer size table based on the type of buffer status report.

In some example embodiments, the first apparatus comprises a terminal device, and the second apparatus comprises a network device.

In some example embodiments, the first apparatus further comprises means for performing other operations in some example embodiments of the method 600 or the device 110. In some example embodiments, the means comprises at least one processor; and at least one memory storing instructions that, when executed by the at least one processor, cause the performance of the first apparatus.

In some example embodiments, a second apparatus capable of performing any of the method 700 (for example, the device 120 in FIG. 1) may comprise means for performing the respective operations of the method 700. The means may be implemented in any suitable form. For example, the means may be implemented in a circuitry or software module. The second apparatus may be implemented as or included in the device 120 in FIG. 1.

In some example embodiments, the second apparatus comprises means for transmitting, to a first apparatus, a first configuration of one or more logical channel groups; means for transmitting, to the first apparatus, a second configuration indicating whether at least one logical channel group of the one or more logical channel groups is able to use a second buffer size table in addition to a first set of buffer size tables; and means for receiving, from the first apparatus, a buffer status report for the at least one logical channel group that is based on a target buffer size table, wherein the target buffer size table is determined from the first set of buffer size tables and the second buffer size table based on a type of buffer status report.

In some example embodiments, the type of buffer status report comprises at least one of: a padding buffer status report, a regular buffer status report, a periodic buffer status report, a short buffer status report, a short truncated buffer status report, a long buffer status report, a long truncated buffer status report, a further long buffer status report which is different from the long buffer status report, or a further long truncated buffer status report which is different from the long truncated buffer status report.

In some example embodiments, the second apparatus further comprises: means for in accordance with a determination that the buffer status report is the padding buffer status report and the type of buffer status report is the short buffer status report or the short truncated buffer status report and there is one byte space for buffer status report payload, receiving, from the first apparatus, the buffer status report that is based on a buffer size table from the first set of buffer size tables.

In some example embodiments, the second apparatus further comprises: means for in accordance with a determination that the type of buffer status report is the long buffer status report or the long truncated buffer status report and the at least one logical channel group uses a further buffer size table from the first set of buffer size tables, receiving, from the first apparatus, the buffer status report for the one or more logical channel groups based on the further buffer size table from the first set of buffer size tables.

In some example embodiments, the second apparatus further comprises: means for in accordance with a determination that none of at least one logical channel group uses the first set of buffer size tables, receiving, from the first apparatus, the buffer status report for the at least one logical channel group that is based on the second buffer size table, wherein the buffer status report is the further long truncated buffer status report or the further long buffer status report.

In some example embodiments, the second apparatus further comprises: means for in accordance with a determination that another logical channel group in the one or more logical channel groups uses the first set of buffer size tables, receiving, from the first apparatus, another buffer status report for the other logical channel group based on the first set buffer size tables.

In some example embodiments, the second apparatus further comprises: means for receiving, from the first apparatus, the buffer status report in a medium access control (MAC) control element (CE) format that includes a field indicating whether the at least one logical channel group uses the target buffer size table from the first set buffer size tables.

In some example embodiments, the second apparatus further comprises: means for receiving, from the first apparatus, the buffer status report that comprises a logical channel identity indicating whether the second buffer size table is used.

In some example embodiments, the second apparatus further comprises: means for transmitting, to the first apparatus, a configuration of a 5-bit short buffer status report or a short truncated buffer status report via one of: a radio resource control signaling, a MAC CE, or means for downlinking control information.

In some example embodiments, in accordance with a determination that the configuration of the buffer status report is configured via the radio resource control signaling, the configuration of the buffer status is included in a buffer status report configuration message.

In some example embodiments, the second apparatus further comprises: means for in accordance with a determination that the buffer status report is the padding buffer status report, receiving, from the first apparatus, the buffer status report when padding bits for the buffer status report are available.

In some example embodiments, the second apparatus further comprises: means for in accordance with a determination that a first buffer status report for a first logical channel group using the first set of buffer size tables and a second buffer status report for a second logical channel group using the second buffer size table are to be reported, receiving, from the first apparatus the first buffer status report and the second buffer status report in different MAC CEs.

In some example embodiments, the second apparatus further comprises: means for in accordance with a determination that a first buffer status report for a first logical channel group using the first set of buffer size tables and a second buffer status report for a second logical channel group using the second buffer size table are to be reported, receiving, from the first apparatus the first buffer status report and the second buffer status report in a same MAC CE that comprises an indication indicating which buffer size table is used.

In some example embodiments, the second apparatus further comprises: means for in accordance with a determination that the buffer status report is the padding buffer status report and at least one of logical channel groups to be reported uses the second buffer size table, receiving, from the first apparatus the padding buffer status report for the logical channel groups based on the target buffer size table determined from the first set of buffer size tables.

In some example embodiments, the second apparatus further comprises: in accordance with a determination that the buffer status report is the regular buffer status report or the periodic buffer status report, receiving from the first apparatus the buffer status report based on the target buffer size table determined from the first set of buffer size tables, wherein the number of bits for buffer size in the target buffer size table is same as that of the second buffer size table.

In some example embodiments, the first apparatus comprises a terminal device, and the second apparatus comprises a network device.

In some example embodiments, the second apparatus further comprises means for performing other operations in some example embodiments of the method 700 or the device 120. In some example embodiments, the means comprises at least one processor; and at least one memory storing instructions that, when executed by the at least one processor, cause the performance of the second apparatus.

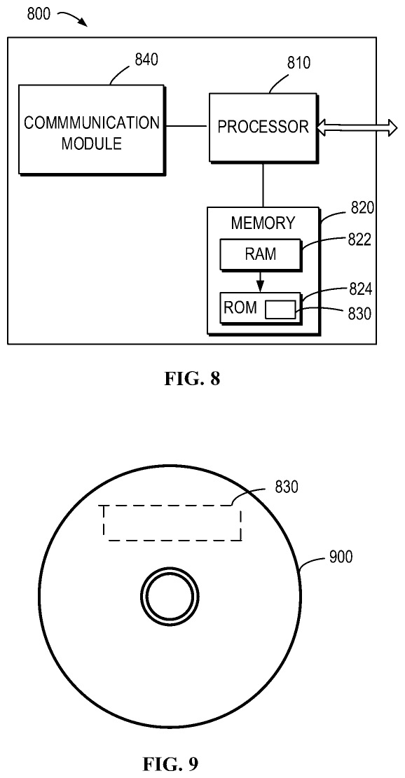

FIG. 8 is a simplified block diagram of a device 800 that is suitable for implementing example embodiments of the present disclosure. The device 800 may be provided to implement a communication device, for example, the device 110 or the device 120 as shown in FIG. 1. As shown, the device 800 includes one or more processors 810, one or more memories 820 coupled to the processor 810, and one or more communication modules 840 coupled to the processor 810.

The communication module 840 is for bidirectional communications. The communication module 840 has one or more communication interfaces to facilitate communication with one or more other modules or devices. The communication interfaces may represent any interface that is necessary for communication with other network elements. In some example embodiments, the communication module 840 may include at least one antenna.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The instructions of the program 830 may include instructions for performing operations/acts of some example embodiments of the present disclosure. The program 830 may be stored in the memory, e.g., the ROM 824. The processor 810 may perform any suitable actions and processing by loading the program 830 into the RAM 822.

The example embodiments of the present disclosure may be implemented by means of the program 830 so that the device 800 may perform any process of the disclosure as discussed with reference to FIG. 2 to FIG. 7. The example embodiments of the present disclosure may also be implemented by hardware or by a combination of software and hardware.

In some example embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 9 shows an example of the computer readable medium 900 which may be in form of CD, DVD or other optical storage disk. The computer readable medium 900 has the program 830 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory storing instructions that, when executed by the at least one processor, cause the first device to:
receive, from a second device, a first configuration of one or more logical channel groups;
receive, from the second device, a second configuration indicating whether at least one logical channel group of the one or more logical channel groups is able to use a second buffer size table in addition to a first set of buffer size tables;
determine, from the first set of buffer size tables and the second buffer size table, a target buffer size table to be used for a buffer status report of the at least one logical channel group based on a type of buffer status report; and
transmit, to the second device, the buffer status report that is based on the target buffer size table.

2. The first device of claim 1, wherein the type of buffer status report comprises at least one of:
a padding buffer status report,
a regular buffer status report,
a periodic buffer status report,
a short buffer status report,
a short truncated buffer status report,
a long buffer status report,
a long truncated buffer status report,
a further long buffer status report which is different from the long buffer status report, or
a further long truncated buffer status report which is different from the long truncated buffer status report.

3. The first device of claim 1, wherein the first device is caused to:
determine that the buffer status report is the padding buffer status report;
in an accordance with a determination that the type of buffer status report is the short buffer status report or the short truncated buffer status report, determine a space for padding buffer status report payload; and
in accordance with a determination that there is one byte space for the buffer status report payload, transmit to the second device, the buffer status report that is based on a buffer size table from the first set of buffer size tables.

4. The first device of claim 1, wherein the first device is caused to:
in accordance with a determination that the type of buffer status report is the long buffer status report or the long truncated buffer status report, determine that whether the at least one logical channel group uses a further buffer size table from the first set of buffer size tables; and
in accordance with a determination that the at least one logical channel group uses the further buffer size table, transmit to the second device, the buffer status report that is based on the further buffer size table.

5. The first device of claim 1, wherein the first device is caused to:
determine that none of the at least one logical channel group uses the first set buffer size tables; and
transmit, to the second device, the buffer status report that is based on the second buffer size table, wherein the buffer status report is the further long truncated buffer status report or the further long buffer status report.

6. The first device of claim 5, wherein the first device is caused to:
determine that another logical channel group in the one or more logical channel groups uses the first set of buffer size tables; and
transmit, to the second device, another buffer status report for the other logical channel group based on the first set of buffer size tables.

7. The first device of claim 1, wherein the first device is caused to:
transmit, to the second device, the buffer status report in a medium access control (MAC) control element (CE) format that includes a field indicating whether the at least one logical channel group uses the target buffer size table from determined the first set buffer size tables.

8. The first device of claim 1, wherein the first device is caused to:
transmit, to the second device, the buffer status report that comprises a logical channel identity indicating whether the second buffer size table is used.

9. The first device of claim 1, wherein the first device is further caused to:
receive, from the second device, a configuration of a 5-bit short buffer status report or a short truncated buffer status report via one of:
a radio resource control signaling,
a MAC CE, or
downlink control information.

10. The first device of claim 9, wherein in accordance with a determination that the configuration of the buffer status report is configured via the radio resource control signaling, the configuration of the buffer status is included in a buffer status report configuration message.

11. The first device of claim 1, wherein the first device is caused to:
in accordance with a determination that the type of buffer status report is the padding buffer status report, transmit, to the second device, the buffer status report when padding bits for the buffer status report are available.

12. The first device of claim 1, wherein the first device is caused to:
in accordance with a determination that a first buffer status report for a first logical channel group using the first set of buffer size tables and a second buffer status report for a second logical channel group using the second buffer size table are to be reported, transmit, to the second device, the first buffer status report and the second buffer status report in different MAC CEs.

13. The first device of claim 1, wherein the first device is caused to:
in accordance with a determination that a first buffer status report for a first logical channel group using the first set of buffer size tables and a second buffer status report for a second logical channel group using the second buffer size table are to be reported, transmit, to the second device, the first buffer status report and the second buffer status report in a same MAC CE that comprises an indication indicating which buffer size table is used.

14. The first device of claim 1, wherein the first device is caused to:
determine that the buffer status report is the padding buffer status report; and
in accordance with a determination that at least one of logical channel groups to be reported uses the first set of buffer size tables, transmit, to the second device, the buffer status report for all of the logical channel groups based on the target buffer size table determined from the first set of buffer size tables.

15. The first device of claim 1, wherein the first device is caused to:
in accordance with a determination that the buffer status report is the regular buffer status report or the periodic buffer status report, determine the target buffer size table from the first set of buffer size tables, wherein the number of bits for buffer size in the target buffer size table is same as that of the second buffer size table; and
transmit to the second device the buffer status report based on the target buffer size table.

16. The first device of claim 1, wherein the first set of buffer size tables includes a 5-bit buffer size table and an 8-bit buffer size table,
wherein the first device is caused to:
in accordance with a determination that the target buffer size table is determined from the first set of buffer size tables, determine the target buffer size table to be the 5-bit buffer size table or the 8-bit buffer size table based on the type of buffer status report.

17. The first device of claim 1, wherein the first device comprises a terminal device, and the second device comprises a network device.

18. A second device comprising:
at least one processor; and
at least one memory storing instructions that, when executed by the at least one processor, cause the second device to:
transmit, to a first device, a first configuration of one or more logical channel groups;
transmit, to the first device, a second configuration indicating whether at least one logical channel group of the one or more logical channel groups is able to use a second buffer size table in addition to a first set of buffer size tables; and
receive, from the first device, a buffer status report for the at least one logical channel group that is based on a target buffer size table, wherein the target buffer size table is determined from the first set of buffer size tables and the second buffer size table based on a type of buffer status report.

19-33. (canceled)

34. A method comprising:
receiving, at a first device and from a second device, a first configuration of one or more logical channel groups;
receiving, from the second device, a second configuration indicating whether at least one logical channel group of the one or more logical channel groups is able to use a second buffer size table in addition to a first set of buffer size tables;
determining, from the first set of buffer size tables and the second buffer size table, a target buffer size table to be used for a buffer status report of the at least one logical channel group based on a type of buffer status report; and
transmitting, to the second device, the buffer status report that is based on the target buffer size table.

35-38. (canceled)
